(19) United States
(12) Patent Application Publication
(10) Pub. No.: US 2010/0092614 A1
(43) Pub. Date: Apr. 15, 2010

(54) METHOD FOR THE CONTINUOUS PRODUCTION OF DEGRADED STARCH PASTE AND SYSTEM FOR PERFORMING SUCH A METHOD

(75) Inventor: Jochen Bauer, Eresing/Pflaumdorf (DE)

Correspondence Address: JORDAN AND HAMBURG LLP, 122 EAST 42ND STREET, SUITE 4000, NEW YORK, NY, 10168, US

(73) Assignee: BVG BAUER VERFAHRENSTECHNIK GMBH, Greifenberg (DE)

(21) Appl. No.: 12/450,058

(22) PCT Filed: Mar. 7, 2008
(86) PCT No.: PCT/EP2008/052787

§ 371 Date: Oct. 5, 2009

(30) Foreign Application Priority Data
Mar. 8, 2007 (DE) 10 2007 011 409.7

(51) Int. Cl. A23L 1/0522

(52) U.S. Cl. 426/64

(57) ABSTRACT

The invention describes a method for the continuous production of enzymatically degraded starch paste, wherein a starch suspension and at least at times an enzyme are fed to a reaction vessel and from there a starch paste, which is degraded at the same time, is continuously removed. To this end, a highly turbulent state is generated in the reaction vessel, the state resulting in a high mixing rate of the enzyme and starch suspension. Furthermore, the invention relates to a system or performing the method according to the invention for the continuous production of enzymatically degraded starch paste.

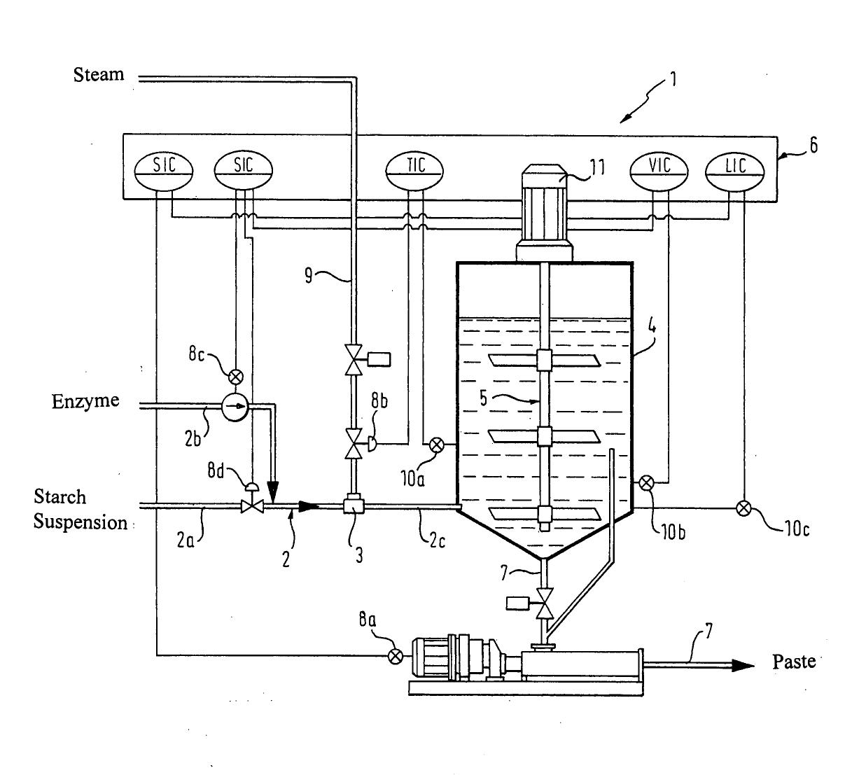

### BACKGROUND OF THE INVENTION

The invention relates to a method for the continuous production of starch paste from enzymatically degraded starch that is used for instance in the paper industry, and relates to a system for performing such a method.

The continuous production of enzymatically degraded starch paste is normally performed in a so-called “plug flow” method. In this method, which is also known as the piston flow method, a starch suspension is agglutinated by heating, starch-degrading enzymes (amylases) are added, and the mixture is continuously conducted through a corresponding “plug flow” converter in which the enzymatic degradation of the starch molecules occurs.

The goal of the plug flow method is to attain the same dwell time for each starch molecule in the plug flow converter. An attempt is made to guide the starch through the converter continuously in layers in order to assure the same dwell time in the converter for all of the starch molecules. Most of the time a stirrer is not used in the plug flow converter so that the required stratified flow can be produced. Moreover, as a rule screen plates are built into the converter in order to prevent turbulence from forming in the converter.

In general it is taught that when producing degraded starch paste in continuous operations the same dwell time must be attained in the converter for each starch molecule in order to subject each starch molecule equally to enzymatic degradation because enzymatic conversion reactions are a function of time. The prevailing belief is that desired properties for the degraded starch paste cannot be attained unless this basic requirement is met.

It is disadvantageous in the prior art that, due to the equal exposure time of the enzymes to the starch molecules in the plug flow converter, all of the starch molecules experience the same degree of enzymatic degradation, which results in worsening of the properties for the degraded starch paste.

It is also a disadvantage of the prior art that due to the activity of the amylases that act on all of the starch molecules for the same length of time a high glucose content is produced in the degraded starch paste and this high glucose content reduces the adhesive force of the degraded starch paste.

It is furthermore disadvantageous that because turbulence is prevented in the plug flow converter the starch paste and the enzymes are only mixed unsatisfactorily with one another during the reaction. This limits the efficiency of the degradative reaction and makes it necessary to use greater quantities of degrading enzymes.

The desired prevention of turbulence within the converter in the “plug flow” method furthermore leads to increased deposits of the starch paste in areas of the converter in which there is no flow or only very minor flow. This so-called vortex formation leads to increased heterogeneity of the starch paste and can lead to clogging of smaller openings, for instance inside of valves. Moreover, deposits that form on error sensing devices in the converter can lead to imprecise measured values and thus make it more difficult to produce a uniform paste quality.

The occurrence of deposits in “plug flow” converters furthermore has the consequence that the converters must be cleaned more frequently and more intensively. This results in increased costs that have a negative impact on the efficiency of the method due to the increased consumption of waste water and the idleness of the converter during the cleaning phases.

U.S. Pat. No. 4,014,743 describes a continuous method for producing a starch paste in which an aqueous starch suspension and an enzyme solution are added to a stirred vessel and stirred there. The stirred vessel has a stirrer and is heated by steam. The degraded starch leaves the vessel at the lower end. The reactants (starch suspension and enzyme solution) are fed proportionately to the product which leaves the vessel. The reaction is monitored by measuring the viscosity of the product. The enzyme (in the product solution) is deactivated after leaving the vessel.

WO 00/11957 also provides one skilled in the art the information that agglutination and complete hydrolysis of the starch used, which in the method is also likewise prepared exclusively in a stirred vessel with the addition of water and enzymes, normally takes about an hour. This method is a so-called plug flow method, that is, the input and output materials do not flow continuously but rather in a type of plug flow.

DE 37 31 293 A1 is especially concerned with the using the method to increase the final concentration of starch in the starch paste to a solid content of up to 70% starch, measured in the dry substance. It can be seen from this that in the past the general teaching for producing paste has assumed that the more starch processed in the paste, the more strongly its properties are improved. This takes for granted that when paste is produced in this manner a long dwell time in the stirred vessel is needed for the starch molecules, which are supplied separately from the enzymes, for attaining a desired adhesive force. It is possible to take directly from this that a stratification of the starch suspension with enzymes is built up from the top to the bottom in the stirred vessel, the dwell time increasing from top to bottom.

DE 21 59 315, which describes a non-continuous method for producing starch paste with agglutination in a reaction chamber, does not contain any information about how a dwell time or exposure time can be reduced enough that the employed can be used as paste in the shortest possible time. DE 21 59 315 does not extend beyond a conventional plug flow method for increasing the starch concentration in the paste and thus does not provide one skilled in the art any additional information.

Application DE 1 243 120 depicts a system in which a semi-continuous starch degradation reaction occurs exclusively in one reactor. In this case in principle it is possible to supply the input materials continuously and to remove the final product continuously. However, in this method, as is usual in all conventional methods, starch degradation buffers are provided that make it possible for the starch or the individual starch molecules to remain inside the reactor for a certain dwell time, in this case preferably for the reaction time.

### SUMMARY OF THE INVENTION

The object of the invention is to provide a method for continuous production of degraded starch paste that is improved relative to the prior art and with which degraded starch paste is produced, the properties of which are improved relative to the degraded starch paste produced with known methods. It is furthermore the object of the invention to provide a system for performing this improved method.

In the inventive method for the continuous production of enzymatically degraded starch paste, starch suspension including starch molecules and, at least for a period of time, enzyme are added to a reaction vessel in which an enzymatic degradation takes place and degraded starch paste is simultaneously continuously removed from the reaction vessel. A condition is created in the reaction vessel that is so highly turbulent that even with the briefest dwell time for individual starch molecules their degradation occurs corresponding to the properties desired for the starch paste.

The briefest dwell time shall be construed as the time interval that a starch molecule requires in order to move from the point of entry into the reaction vessel, travel the shortest path, and reach the point of exit out of the reaction vessel.

The properties desired for the starch paste that are created by the inventive method shall be construed as the properties of the degraded starch paste that are determined by the physical and molecular nature of the starch paste. Preferred as desired properties is high adhesive force, furthermore preferred as a desired property is good processability or good storability. Furthermore preferred as desired properties are combinations of high adhesive force, good processability, and good storability.

The highly turbulent condition that is created in the reaction vessel in accordance with the inventive method effects optimum mixing of the enzyme added to the starch paste. A reaction vessel that is preferably embodied as a stirred vessel is used for producing this highly turbulent condition.

The properties of the stirred vessel preferably approximate the properties of an ideal stirred vessel. In an ideal stirred vessel the reactants and the products resulting from the reaction of the reactants are mixed completely. In an ideal stirred vessel, the inflowing reactants are mixed with the mass in the reaction chamber of the stirred vessel at infinitely high speed. Since in the stirred vessel, because of the conversion of the reactants and the attendant occurrence of products, there is a lower reactant concentration than in the feed line, there is a jump in concentration in the stirred vessel at the entry point. This means that in an ideal stirred vessel the concentration of reactants that enter the vessel drops immediately upon entering the vessel to the lower concentration that prevails in the vessel.

Furthermore, the concentration of all substances in the ideal stirred vessel is equal temporally and locally. The starch molecules entering the stirred vessel have a mean dwell time rather than the same dwell time in the stirred vessel. Individual starch molecules can have a very long dwell time in the stirred vessel and other starch molecules can have a very short dwell time.

In the inventive method, the dwell time of a starch molecule in the reaction vessel is preferably one second (1 s) to one hour (1 h).

The enzyme that degrades the starch molecule in accordance with the inventive method is preferably an amylase. Amylases are hydrolases that split the starch molecules hydrolytically at the glycosidic bond. Amylases are also classified as saccharidases, that is, enzymes, that split polysaccharides. Furthermore, the enzyme used in the inventive method is preferably an alpha-amylase. The use of beta-amylases is also preferred. Furthermore preferred is a combination of alpha and beta-amylases.

The use of native or modified amylases is preferred. Considered as native amylases are amylases that are obtained from naturally occurring organisms or whose molecular properties, such as for instance the amino acid sequence, corresponds to the molecular properties of amylases obtained from naturally occurring organisms. Considered as modified amylases are amylases that were modified with respect to their molecular properties, such as for instance their amino acid sequence, for instance using genetic engineering methods. Amylases that have a reaction optimum of 75-90° C. are preferred. Furthermore preferred are amylases that are activated by increasing the temperature to up to 75-90° C. The enzyme portion in the inventive method is preferably 0.02%-0.2% relative to the starch.

As an alternative embodiment, in the inventive method preferably one or a plurality of additional polymer-degrading enzymes are added to the starch suspension in addition to the starch-degrading enzyme. Preferred additional enzymes are ligninases, cellulases, hemicellulases, xylanases, and proteases.

The starch molecules included in the starch suspension in the inventive method are preferably native or modified starch molecules. Native starch comprises 10-30% amyloses (linear chains exclusively of alpha-1,4-glycosidically linked glucose molecules) and 70-90% amylopectin (highly branched chains having alpha-1,6-glycosidically and alpha-1,4-glycosidically linked glucose molecules). The native starch is preferably potato starch. In one alternative embodiment the native starch is preferably wheat starch, pea starch, rice starch, corn starch, or tapioca starch. Moreover, a mixture of different types of native starches is preferably used.

Modified starch is preferably used in one alternative embodiment. Modified starch shall be construed as native starch that has been modified chemically, physically, or enzymatically. Preferred modified starch is starch treated with acid, starch treated with bases, starch bleached with bleaching agents such as for instance peroxyacetic acid, hydrogen peroxide, sodium hypochlorite, sodium chlorite, sulfur dioxide, sulfites, potassium permanganate, or ammonium persulfate, enzymatically modified starch, starch modified by oxidation, starch modified by esterification, etherized starch, cationic starch, and starch modified by phosphorylation. In addition, the use of starch modified by reacting with propylene oxide or by acetylation is preferred. Furthermore preferred is the use of a mixture of native and modified starches.

The starch suspension supplied in the inventive method is preferably itself agglutinated prior to entering the reaction vessel or in the reaction vessel. Agglutination is preferably attained by increasing the temperature. During agglutination by increasing the temperature, the starch bonds to water that is a multiple of its weight due to the effect of the heat and therefore swells up. The temperature used for agglutinating the starch suspension is preferably 65-90° C.

In one alternative embodiment the starch suspension can preferably be agglutinated by adding bases. Preferably the increased pH following the agglutination can be readjusted to the optimum pH for the degrading enzyme by adding acids.

Enzyme that is in the starch paste that is removed is preferably deactivated in the inventive method. The deactivation is preferably performed by increasing the temperature. The deactivation temperature is preferably 100-140° C.

In one alternative embodiment, enzyme that is in the removed starch paste can preferably be deactivated by adding an enzyme inhibitor. Preferred enzyme inhibitors are enzyme inhibitors obtained from plants. Also preferred are genetically engineered enzyme inhibitors or alternatively preferably synthetic inhibitors. Enzyme inhibitors are preferably proteins or alternatively preferably other organic compounds.

In another alternative embodiment, the enzyme is deactivated by changing the pH.

The inventive method for the continuous production of enzymatically degraded starch paste can be performed in the inventive system, which has at least one feed line for adding the starch suspension and the enzyme to the reaction vessel, one module for agglutination of the starch suspension, one reaction vessel with an apparatus for creating a turbulent condition therein, one control unit by means of which first signals can be generated for controlling the condition in the reaction vessel, at least one outgoing line for in particular continuous removal of the degraded starch paste from the reaction vessel, and actuators that can be controlled by means of second signals generated by the control unit.

The starch suspension and the enzyme are preferably added to the reaction vessel together via one feed line. The enzyme and the starch suspension are preferably mixed prior to the agglutination of the starch suspension. In one alternative embodiment, the enzyme is added to the starch suspension after the agglutination of the starch suspension. In another alternative embodiment, the starch suspension and the enzyme are added to the reaction vessel via separate feed lines.

The starch suspension is preferably agglutinated prior to entering into the reaction vessel. In one alternative embodiment the agglutination occurs in the reaction vessel.

The apparatus for creating a turbulent condition in the reaction vessel is preferably a stirrer that is preferably driven via a motor that can be controlled by receiving signals from the control unit. Furthermore, however, the reaction vessel preferably also has baffles or other impediments to the flow that are suitable for increasing the turbulent condition in the reaction vessel and thus for attaining even more thorough mixing of starch suspension and enzymes. The reaction vessel preferably has a stirrer and additional baffles or other impediments to the flow. The reaction vessel is preferably a stirred vessel, the properties of which preferably approximate the properties of an ideal stirred vessel.

The reaction vessel is preferably embodied as a stirred vessel that is equipped with a stirrer, the stirring speed of which can be controlled via signals from the control unit so that the turbulent condition in the reaction vessel can be controlled.

Furthermore, preferred controllable conditions in the reaction vessel are the temperature and pH of the starch suspension including the enzyme, the starch suspension concentration, and the enzyme concentration. The inventive system is preferably embodied such that in the reaction vessel one or a plurality of different conditions selected from the group comprising turbulent condition, temperature, pH, starch suspension concentration of the starch suspension including the enzyme, and enzyme concentration of the starch suspension including the enzyme are controlled by the control unit.

For adjusting the pH, in one preferred embodiment the inventive system has one or a plurality of additional controllable feed lines through which acids and bases are introduced into the reaction vessel together or separated from one another.

The actuators for the inventive system are preferably able to control the supply of the starch suspension and the enzyme, the agglutination of the starch suspension, and the removal of the degraded starch paste. The actuators are preferably controlled by the control unit. Furthermore, the actuators are preferably embodied as controllable valves.

The starch suspension and the enzyme are preferably supplied to the reaction vessel at the top of the reaction vessel. Furthermore, the starch suspension and the enzyme are preferably supplied to the reaction vessel at the bottom of the reaction vessel or furthermore preferably from the side of the reaction vessel. The degraded starch paste is preferably removed from the reaction vessel from the bottom of the reaction vessel or furthermore preferably from the side of the reaction vessel.

In one preferred embodiment, the inventive system has a measuring apparatus for measuring the properties of the degraded starch paste in the reaction vessel. The property of the degraded starch paste that is measured by the measuring apparatus is preferably the viscosity of the degraded starch paste. This measuring apparatus is preferably a process online viscometer.

In one alternative embodiment, the measuring apparatus is preferably a measuring apparatus for determining the glucose content of the degraded starch paste. Furthermore, the inventive system preferably has measuring apparatus for determining the pH, the temperature, or the flow speed of the degraded starch paste. The inventive system preferably has a plurality of measuring apparatus for determining one or a plurality of different properties of the degraded starch paste.

In another preferred embodiment, the inventive system has measuring apparatus in the feed and outgoing lines for the inventive system. In one preferred embodiment, the inventive system has measuring apparatus in the feed and outgoing lines for the system and additionally has measuring apparatus in the reaction vessel. In one preferred embodiment, the inventive system has measuring apparatus not only for determining the properties of the degraded starch paste, but also has measuring apparatus for determining the properties of the supplied starch suspension and the supplied enzyme.

Furthermore, the reaction vessel for the inventive system preferably has measuring apparatus for determining the fill level of the reaction vessel.

In one preferred embodiment, the module for agglutinating the starch suspension in the inventive system is embodied such that the starch suspension can be heated using steam. The module for agglutinating the starch suspension is preferably embodied as a Venturi tube. In one alternative embodiment, the starch suspension is agglutinated by supplying hot water or furthermore preferably by conducting the starch suspension over appropriate heating elements or through heatable feed lines.

Alternatively, the starch suspension is agglutinated in the inventive system by increasing the pH, which is accomplished by adding a suitable base.

The inventive system preferably has another module for deactivating the enzyme. The enzyme is preferably deactivated in this module by increasing the temperature. Furthermore, the module for deactivating the enzyme is preferably embodied such that the degraded starch paste can be heated using steam. In one alternative embodiment, the enzyme is preferably deactivated by changing the pH or by adding enzyme inhibitors. The module for deactivating the enzyme can preferably be controlled using signals from the control unit for the inventive system.

### BRIEF DESCRIPTION OF THE DRAWING

Additional advantages and potential applications for the inventive system are explained using the following schematic FIGURE.

### DETAILED DESCRIPTION OF THE INVENTION

The FIGURE depicts a system (1) for the continuous production of enzymatically degraded starch paste according to the inventive method. The starch suspension and an enzyme are added to a stirred vessel (4) via a feed line (2). The enzyme is conducted via an enzyme feed line (2b) into a starch suspension feed line (2a), where it mixes with the starch suspension. The mixture of enzyme and starch suspension is added to the reaction vessel via an enzyme/starch suspension feed line (2c). Prior to entering the stirred vessel (4), the mixture of enzyme and starch suspension is conducted through an agglutination module (3) that can be embodied as a Venturi tube and in which the starch suspension is agglutinated. The stirred vessel (4) is equipped with a stirrer (5) for creating a turbulent condition in the stirred vessel. The stirrer is driven by a stirrer motor (11). A control unit (6) controls the activity of the stirrer motor (11) and thus controls the turbulent condition in the stirred vessel (4). The degraded starch paste that is formed in the stirred vessel (4) is removed from the stirred vessel (4) via an outgoing line (7). Actuators labeled with reference numbers 8a, 8b, 8c, and 8d control the removal of the degraded starch paste (starch paste removal actuator, 8a), the agglutination of the starch suspension (agglutination actuator, 8b), the supply of the enzyme (enzyme supply actuator, 8c), and the supply of the starch suspension (starch suspension supply actuator, 8d). The actuators (8a, 8b, 8c, 8d) are controlled using appropriate signals generated by the control unit (6).

The agglutination of the starch suspension in the agglutination module (3) is caused by the addition of steam via a steam line (9). A plurality of measuring apparatus (10a, 10b, 10c) measure different properties of the degraded starch paste in the stirred vessel and forward the measured values to the control unit (6). The control unit (6) tallies the measured values obtained and using appropriate signals controls the actuators (8a, 8b, 8c, 8d) and the motor for the stirrer (11).

1. Method for continuous production of starch paste from enzymatically degraded starch, comprising continuously feeding a mixture of starch suspension, enzyme for degrading molecules of the starch, and water, the mixture containing agglutinated starch molecules, to a reaction vessel through a feed line and is simultaneously continuously removing starch paste from the reaction vessel.

2. Method in accordance with claim 1, wherein the reaction vessel is a stirred vessel.

3. Method in accordance with claim 2, wherein a highly turbulent condition is created in the stirred vessel.

4. Method in accordance with claim 1 wherein the enzyme for degrading the starch molecules is an amylase.

5. Method in accordance with claim 1, wherein the starch molecules are native or modified starch molecules.

6. Method in accordance with claim 1, further comprising agglutinating the starch molecules in the starch suspension of the mixture prior to entry of the mixture into the reaction vessel.

7. Method in accordance with claim 6, wherein the agglutination is effected in a Venturi tube.

8. Method in accordance with claim 19, wherein the starch suspension is heated using steam for the agglutination.

9. Method in accordance with claim 1 wherein the feed line enters the reaction vessel at a bottom, top, or side thereof.

10. Method in accordance with claim 1 wherein the removal of the starch paste from the reaction vessel is through a discharge line.

11. Method in accordance with claim 1, wherein dwell time for a starch molecule in the reaction vessel is 1 s up to 1 h.

12. Method in accordance with claim 1, further comprising deactivating enzyme that is in the removed starch paste.

13. System for the continuous production of starch paste from enzymatically degraded starch comprising a reaction vessel, a feed line for simultaneously feeding starch suspension, enzyme, and water together to the reaction vessel, a module for agglutinating the starch suspension upstream of the reaction vessel, an apparatus for creating a turbulent flow condition in the reaction vessel, a discharge line for continuously removing degraded starch paste from the reaction vessel, actuators controlling the feeding of the starch suspension, enzyme, and water, the agglutination of the starch suspension, and the removal of the degraded starch paste and a control unit for generating first signals for controlling a condition in the reaction vessel and a second signal for controlling the actuators.

14. System in accordance with claim 13, wherein the reaction vessel is a stirred vessel and the system further comprises a viscometer for measuring viscosity of degraded starch paste in the reaction vessel.

15. System in accordance with claim 13, wherein the module for agglutinating the starch suspension comprises apparatus for heating the starch suspension with steam.

16. System in accordance with claim 13, further comprising a module for deactivating enzyme in the removed starch paste.

17. System in accordance with claim 16, wherein the module for deactivating the enzyme comprises apparatus for heating the removed degraded starch paste with steam.

18. System in accordance with claim 13, wherein the reaction vessel is a stirred vessel and has baffles or other impediments to flow for increasing turbulence in the reaction vessel.

19. Method in accordance with claim 6, in which the agglutinating comprises increasing temperature of the starch suspension.

20. Method in accordance with claim 12, wherein the enzyme deactivating comprises increasing temperature of the removed starch paste.
